(19) United States
(12) Patent Application Publication
(10) Pub. No.: US 2026/0349647 A1
(43) Pub. Date: Nov. 5, 2026

(54) SYSTEM, METHOD AND APPARATUS FOR PROXIMITY-BASED CONTROLS OF ELECTRONIC DEVICES

(71) Applicant: Quantum Automation Solutions LLC, Summerville, SC (US)

(72) Inventor: Timothy J. Jones, Summerville, SC (US)

(21) Appl. No.: 19/195,176

(22) Filed: Apr. 30, 2025

(51) Int. Cl. G06F 3/16; G06F 3/01; G06K 7/10; G06V 40/10; G10L 17/22; H04R 3/12

(52) U.S. Cl. CPC G06F 3/165; G06F 3/011; G06K 7/10366; H04R 3/12; G06V 40/10; G10L 17/22; H04R 2430/01

(57) ABSTRACT

An environmental sound control system. Aspects of the present disclosure provide for a hands-free, proximity-based system to control a volume level of an audio output at a television, or speakers located within an interior environment; for example, a hospital room. Embodiments of the present disclosure may include a networked system configured to independently control the volume of a specific speaker while maintaining the same volume at other speakers. The environmental sound control system may comprise one or more wireless interfaces configured to detect the presence of a user at a specific location or within a specific boundary of an interior space.

### FIELD

The present disclosure relates to the field of remote control of electronic devices; in particular, a system and method for wireless and hands-free control of audio volume based on the presence of an occupant in an interior environment.

### BACKGROUND

In healthcare environments, background music is often used to create a calming atmosphere for patients undergoing treatment. Studies have shown that soothing music can reduce anxiety, improve patient experience, and even contribute to pain management. However, maintaining an appropriate balance between patient comfort and effective communication between healthcare providers and patients presents a challenge.

When doctors, nurses, or other medical personnel enter a patient's room, it is critical that verbal communication is clear and unhindered. Loud background music can impede discussions related to diagnosis, treatment, or medication instructions, potentially leading to miscommunication or errors. In many cases, healthcare providers must manually adjust or turn off music, which can be inefficient, disruptive, or even overlooked in high-paced medical settings. Existing solutions rely on manual intervention or preset timers, neither of which dynamically respond to real-time activity in the room.

### SUMMARY

The following presents a simplified summary of some embodiments of the invention in order to provide a basic understanding of the invention. This summary is not an extensive overview of the invention. It is not intended to identify key/critical elements of the invention or to delineate the scope of the invention. Its sole purpose is to present some embodiments of the invention in a simplified form as a prelude to the more detailed description that is presented later.

Certain aspects of the present disclosure provide for an audio control system comprising a radio frequency transmitter comprising a radio frequency antenna and a digital storage medium comprising identification data encoded thereon. In certain embodiments, the radio frequency transmitter is configured to transmit a radio frequency comprising a data packet containing the identification data. The audio control system may further comprise a radio frequency receiver communicably engaged with the radio frequency transmitter. In certain embodiments, the radio frequency receiver is configured to receive the transmitted radio frequency and process the data packet to decode the identification data. The audio control system may further comprise an audio controller communicably engaged with the radio frequency receiver to receive the decoded identification data. In certain embodiments, the audio controller is configured to process the decoded identification data to identify at least one user associated with the identification data. In certain embodiments, upon identifying the at least one user, the audio controller is configured to apply one or more audio controls to a digital audio output. The audio control system may further comprise at least one loudspeaker operably engaged with the audio controller to render the digital audio output. In certain embodiments, the one or more audio controls comprise lowering a volume level of the digital audio output at the at least one loudspeaker to a preset level.

In accordance with certain embodiments of the audio control system, the one or more audio controls may comprise one or more preset volume parameters associated with the user. In certain embodiments, the radio frequency receiver is configured to monitor a strength of the transmitted radio frequency to determine whether the radio frequency transmitter is outside of a specified range. In certain embodiments, the radio frequency receiver is configured to communicate a signal to the audio controller in response to determining that the radio frequency transmitter is outside of the specified range. In certain embodiments, the audio controller is configured to raise the volume level of the digital audio output to a preset level at the at least one loudspeaker in response to the signal from the radio frequency receiver. In certain embodiments, the radio frequency transmitter comprises a passive radio frequency identification tag. In certain embodiments, the radio frequency receiver comprises a radio frequency transceiver configured to energize the passive radio frequency identification tag to transmit the radio frequency. In certain embodiments, the one or more audio controls comprise a first set of audio controls configured for a first user and a second set of audio controls configured for a second user, wherein the first set of audio controls is different from the second set of audio controls. In certain embodiments, the audio controller is configured to identify the first user or the second user in response to processing the decoded identification data.

Further aspects of the present disclosure provide for an audio control system comprising a sensor device configured to sense a presence of an occupant in an interior environment. The system may further comprise an audio controller communicably engaged with the sensor device. The sensor device may be configured to send a sensor input signal to the audio controller in response to sensing the occupant in the interior environment. The audio controller may be configured to process the sensor input signal according to at least one processing framework to identify at least one occupant type. The audio controller may be configured to apply one or more audio controls to a digital audio output upon identifying the at least one occupant type. The system may further comprise at least one loudspeaker operably engaged with the audio controller to render the digital audio output. The one or more audio controls may comprise lowering a volume level of the digital audio output at the at least one loudspeaker to a preset level.

In accordance with certain embodiments of the audio control system, the sensor device is selected from the group consisting of an acoustic transducer, a digital camera, an optical sensor, an ultrasonic sensor, an imaging sensor, an infrared sensor, and a passive infrared sensor. In certain embodiments, the one or more audio controls may comprise a first set of audio controls configured for a first occupant type and a second set of audio controls configured for a second occupant type, wherein the first set of audio controls is different from the second set of audio controls. The at least one processing framework may be configured to identify the at least one occupant type according to a voice input from an occupant received at the sensor device. The at least one processing framework may be configured to identify the at least one occupant type according to an image recognition framework. In said embodiments, the sensor device may comprise a digital camera.

Still further aspects of the present disclosure provide for an audio control system comprising a mobile electronic device configured to transmit at least one wireless signal comprising at least one data packet. The system may further comprise a controller configured to receive the at least one wireless signal from the mobile electronic device and process the at least one data packet according to at least one processing framework to identify the mobile electronic device. The system may further comprise a first loudspeaker located in a first location of an interior environment and configured to render an audio output, wherein the first loudspeaker is operably engaged with the controller to control a first volume level of the audio output. The system may further comprise a second loudspeaker located in a second location of the interior environment and configured to render the audio output. In certain embodiments, the second loudspeaker is operably engaged with the controller to control a second volume level of the audio output. In certain embodiments, the controller is configured to determine a proximity of the mobile electronic device relative to the first location of the interior environment and the second location of the interior environment. In certain embodiments, the controller is configured to independently control the first volume level of the first loudspeaker and the second volume level of the second loudspeaker according to the proximity of the mobile electronic device relative to the first location of the interior environment or the second location of the interior environment. In certain embodiments, the controller is configured to process the at least one data packet to determine at least one occupant type or occupant identity. In certain embodiments, the controller is configured to control the first volume level of the first loudspeaker and/or the second volume level of the second loudspeaker according to the at least one occupant type or the occupant identity. In certain embodiments, the mobile electronic device is selected from the group consisting of a passive radio frequency identification tag, a smart phone, a radio frequency transmitter, a smart watch, and a wearable activity tracker. In certain embodiments, the controller further comprises a user interface configured to enable a user to configure one or more audio controls for the first loudspeaker and the second loudspeaker.

The foregoing has outlined rather broadly the more pertinent and important features of the present invention so that the detailed description of the invention that follows may be better understood and so that the present contribution to the art can be more fully appreciated. Additional features of the invention will be described hereinafter which form the subject of the claims of the invention. It should be appreciated by those skilled in the art that the conception and the disclosed specific methods and structures may be readily utilized as a basis for modifying or designing other structures for carrying out the same purposes of the present invention. It should be realized by those skilled in the art that such equivalent structures do not depart from the spirit and scope of the invention as set forth in the appended claims.

### BRIEF DESCRIPTION OF DRAWINGS

The skilled artisan will understand that the figures, described herein, are for illustration purposes only. It is to be understood that in some instances various aspects of the described implementations may be shown exaggerated or enlarged to facilitate an understanding of the described implementations. In the drawings, like reference characters generally refer to like features, functionally similar and/or structurally similar elements throughout the various drawings. The drawings are not necessarily to scale, emphasis instead being placed upon illustrating the principles of the teachings. The drawings are not intended to limit the scope of the present teachings in any way. The systems, methods and devices of the present disclosure may be better understood from the following illustrative description with reference to the following drawings in which:

FIG. 1 is a system architecture diagram of an embodiment of an environmental sound control system, in accordance with certain aspects of the present disclosure;

FIG. 2 is a system architecture diagram of an alternative embodiment of an environmental sound control system, in accordance with certain aspects of the present disclosure;

FIG. 3 is a system architecture diagram of an alternative embodiment of an environmental sound control system, in accordance with certain aspects of the present disclosure;

FIG. 4 is a process flow diagram of a routine for an environmental sound control system, in accordance with certain aspects of the present disclosure;

FIG. 5 is a process flow diagram of a routine for an environmental sound control system, in accordance with certain aspects of the present disclosure;

FIG. 6 is a process flow diagram of a routine for an environmental sound control system, in accordance with certain aspects of the present disclosure;

FIGS. 7A-7B are system architecture diagrams of an environmental sound control system, in accordance with certain aspects of the present disclosure;

FIG. 8 is a process flow diagram of a routine for an environmental sound control system, in accordance with certain aspects of the present disclosure;

FIG. 9 is a block diagram illustrating a representative software architecture, which may be used in conjunction with various hardware architectures herein described; and

FIG. 10 is a block diagram illustrating components of a machine, according to some exemplary embodiments, able to read instructions from a machine-readable medium (e.g., a machine-readable storage medium) and perform any one or more of the methodologies discussed herein.

### DETAILED DESCRIPTION

It should be appreciated that all combinations of the concepts discussed in greater detail below (provided such concepts are not mutually inconsistent) are contemplated as being part of the inventive subject matter disclosed herein. It also should be appreciated that terminology explicitly employed herein that also may appear in any disclosure incorporated by reference should be accorded a meaning most consistent with the particular concepts disclosed herein.

Following below are more detailed descriptions of various concepts related to, and embodiments of, inventive methods, apparatus and systems configured to provide for a hands-free, wireless audio control system for use in sensitive environments, such as healthcare providers, hospitals, dental offices and the like, configured to automatically mute or lower the volume of background music or televisions when certain users enter a defined location (e.g., when a healthcare provider enters a patient examination room).

It should be appreciated that various concepts introduced above and discussed in greater detail below may be implemented in any of numerous ways, as the disclosed concepts are not limited to any particular manner of implementation. Examples of specific implementations and applications are provided primarily for illustrative purposes. The present disclosure should in no way be limited to the exemplary implementation and techniques illustrated in the drawings and described below.

Before the present invention and specific exemplary embodiments of the invention are described, it is to be understood that this invention is not limited to the particular embodiments described, and as such may vary. It is also to be understood that the terminology used herein is for the purpose of describing particular embodiments only, and is not intended to be limiting, since the scope of the present invention will be limited only by the appended claims.

Where a range of values is provided, it is understood that each intervening value, to the tenth of the unit of the lower limit unless the context clearly dictates otherwise, between the upper and lower limit of that range and any other stated or intervening value in that stated range is encompassed by the invention. The upper and lower limits of these smaller ranges may independently be included in the smaller ranges, and are also encompassed by the invention, subject to any specifically excluded limit in a stated range. Where a stated range includes one or both of the endpoint limits, ranges excluding either or both of those included endpoints are also included in the scope of the invention.

As used herein, “exemplary” means serving as an example or illustration and does not necessarily denote ideal or best.

As used herein, the term “includes” means includes but is not limited to, the term “including” means including but not limited to. The term “based on” means based at least in part on.

As used herein, the term “interface” refers to any shared boundary across which two or more separate components of a computer system may exchange information. The exchange can be between software, computer hardware, peripheral devices, humans, and combinations thereof.

As used herein, the term “advertising” or “advertisement” refers to any transmitted packet configured to establish a data transfer interface between two electronic devices. An “advertising” or “advertisement” may include, but is not limited to, a BLUETOOTH low energy (BLE) advertising packet transmitted by a peripheral device over at least one Bluetooth advertisement channel.

As used herein, the term “native” refers to any software program that is installed locally on a computing device.

As used herein, the term “peripheral device” refers to any internal or external device that connects directly to a computer but does not contribute to the computer's primary function. In certain embodiments, a peripheral device may include any electronic access control device configured to receive one or more commands from a controller. In certain embodiments, a peripheral device may include any electronic access control device configured to establish a communications interface with a central device. In certain embodiments, a peripheral device may include any device configured to connect to a central device over a wireless communications interface, such as BLUETOOTH. In certain embodiments, a peripheral device may include an electronic device configured to transmit an advertisement. In certain device interactions, the same device may constitute a peripheral device in some instances and a central device in other instances.

As used herein, the term “central device” refers to any electronic device configured to establish a communications interface with a peripheral device. In certain embodiments, a central device may include an electronic device configured to receive an advertisement from a peripheral device.

Certain objects and advantages of the present disclosure include a hands-free, wireless audio control system for use in sensitive environments, such as medical offices, hospitals, dental offices and the like, configured to automatically mute or lower the volume of background music or televisions when certain users enter a defined location (e.g., when a healthcare provider enters a patient examination room).

In accordance with certain exemplary embodiments of the present disclosure, one or more loudspeaker or television may be installed in an interior environment and configured to render an audio output, such as music or a television program. The system may include one or more transmitter, receiver, and/or sensor configured to detect when a user (e.g., a healthcare provider) is in proximity to the loudspeaker and/or television. A controller may be configured to process one or more signals from the transmitter, receiver, and/or sensor to determine the presence and/or identity of the user and automatically modify a volume level of the audio output at the one or more loudspeaker or television. In accordance with certain aspects of the present disclosure, the controller is configured to restore the volume level of the audio output at the one or more loudspeaker or television when the user is outside of a specified proximity to the loudspeaker or television. In accordance with certain embodiments, the system is configured to modify the volume level at a first loudspeaker or television at a first location while maintaining a volume level at a second loudspeaker or television at a second location.

Embodiments of the environmental audio control system of the present disclosure may comprise one or more loudspeaker (e.g., ceiling-mounted, BLUETOOTH, or Wi-Fi connected speaker); an audio source (e.g., streaming music, television, radio, or in-office media system); optionally, an amplifier configured to power speakers and handle volume control; and a controller comprising an electronics assembly configured to command one or more operations of the amplifier. In certain embodiments, the environmental audio control system may comprise a radio frequency identification (RFID) or near-field communication (NFC) badge or tag. The RFID badge or tag may be a passive or active RFID tag. In certain embodiments, the RFID or NFC badge or tag may comprise a building access card or badge associated with one or more third-party electronic access control system. In certain embodiments, the environmental audio control system may comprise an RFID reader or receiver configured to receive an RF signal from the RFID or NFC badge or tag and decode a data packet from the RFID or NFC badge or tag. In certain embodiments, the environmental audio control system may comprise one or more sensors configured to detect user movement within an interior environment (e.g., through a doorway, etc.). The one or more sensors may include an acoustic transducer (e.g., a microphone), a digital camera, an optical sensor, an ultrasonic sensor, an imaging sensor, an infrared sensor, a passive infrared sensor and the like. In certain embodiments, the environmental audio control system may comprise a BLUETOOTH beacon configured to detect the presence of one or more BLUETOOTH-enabled devices (e.g., a smartphone, a smartwatch, etc.) within a specified proximity of the BLUETOOTH beacon. In certain embodiments, the environmental audio control system may comprise a control module configured to control one or more audio output functions based on one or more input signals received by the RFID reader or receiver, and/or the one or more sensors and/or the BLUETOOTH beacon. In certain embodiments, the control module may be operably engaged with one or more voice-controlled digital assistant (e.g., AMAZON ALEXA). In certain embodiments, the control module may comprise a Wi-Fi or BLUETOOTH interface for connection with one or more external devices (e.g., a smartphone) and/or one or more remote or networked servers.

In accordance with certain aspects of the present disclosure, the environmental audio control system may function according to one or more steps or operations wherein (1) music or TV audio plays in one or more location in an interior environment (e.g., a patient treatment room) at a first volume level, (2) a system user (e.g., a medical provider) enters the location, (3) the system performs one or more operations to detect the user's presence including, but not limited to, an RFID sensor reader/receiver detects an RFID-enabled device being worn or carried by the user, and/or a sensor detects the user's presence in the interior environment, and/or a BLUETOOTH device detects a device advertisement from an electronic device being worn or carried by the user, (4) a command is sent to the amplifier or smart speakers or TV to lower the first volume level to a second volume level or mute the volume, (5) the user leaves the location, (6) the system detects the user's absence by the same modality as used to detect the user's presence, and (7) a command is sent to the amplifier or smart speakers or TV to restore the volume to the first volume level or a preset level.

In accordance with certain embodiments, the environmental audio control system may comprise a user device comprising one or more physical controls including, for example, a mute/unmute override button and a volume control button. The system may comprise a companion software application that may be installed on a mobile computing device, such as a smartphone. The companion software application may comprise a graphical user interface configured to configure one or more operational parameters for the system (e.g., user settings, volume presets, permissions, device settings, etc.) and/or control one or more system functions, such as volume adjustment, mute, music source, and the like. In certain embodiments, the system may be operably configured to receive one or more commands from a digital assistant, such as AMAZON ALEXA.

In accordance with an exemplary use case, the environmental audio control system may be installed in an interior environment, such as a dental office comprising multiple patient treatment rooms. In accordance with certain aspects of the present disclosure, one or more speaker may be installed in a location of each patient treatment room, such as the wall or ceiling. The speakers may be connected to an audio source, such as a television, steaming music service, local music player and the like. An audio controller may be operably engaged with the speakers to digitally control the volume of an acoustic audio output at the speakers. In certain embodiments, one or more sensors may be installed in each of the patient treatment rooms. In other embodiments, an RFID receiver may be installed in each of the patient treatment rooms. In said embodiments, the system may comprise an RFID tag or other type of RF transmitter to be worn or carried by the dentist. The one or more sensors and/or the RFID receiver may be configured to detect the presence of the dentist when the dentist enters a patient treatment room. The one or more sensors and/or the RFID receiver may be configured to send a signal to the audio controller upon sensing the presence of the dentist in a patient treatment room. The audio controller may be configured to process the signal to reduce or mute the volume of the acoustic audio output at the speakers in response to the signal.

In accordance with certain aspects of the present disclosure, the environmental audio control system may comprise an RF-enabled badge worn by healthcare personnel. The RF-enabled badge may comprise a third-party ID badge used by healthcare personnel in association with an electronic building access control system. In certain embodiments, the RF-enabled badge may comprise a stand-alone device that may be worn or carried by a user. The RF-enabled badge may be programmed by an administrator user of the environmental audio control system to instantiate one or more automatic sound control functions in the environmental audio control system. The RF-enabled badge may comprise one or more capacitive touch buttons or a simple tactile button interface to control one or more functions of the system, such as volume control, mute, channel selection, and audio source selection. The RF-enabled badge may comprise an LED status light for status feedback. In accordance with certain aspects of the present disclosure, the RF-enabled badge is configured to operably engage with one or more room-specific TVs or hospital speaker systems via one or more wireless communications modalities, including, but not limited to, BLUETOOTH, BLE, IR, or RF. In certain embodiments, the RF-enabled badge may comprise a microphone configured to receive one or more voice inputs from a user. In certain embodiments, the RF-enabled badge may comprise an IR transmitter configured to transmit an IR signal to a television, similar to a universal remote controller. In certain embodiments, the RF-enabled badge may comprise an RF/BLUETOOTH transmitter or transceiver configured to establish a wireless communications interface with a smart TV or centralized audio system. In certain embodiments, the RF-enabled badge may comprise a non-transitory computer-readable storage medium configured to store device information to enable the RF-enabled badge to automatically detect and connect with known devices to avoid interference. In certain embodiments, the RF-enabled badge may comprise a rechargeable or replaceable battery. In certain embodiments, the RF-enabled badge may comprise an antimicrobial casing to prevent bacterial growth and/or a waterproof casing for easy cleaning and sanitation.

Certain objects and advantages of the present disclosure include an environmental audio control system to enable healthcare personnel to adjust the volume of a television or music without the need to search for a remote.

Certain objects and advantages of the present disclosure include an environmental audio control system to reduce noise pollution in healthcare environments to ensure quiet environments for better rest and healing.

Certain objects and advantages of the present disclosure include an environmental audio control system to enhance efficiency in healthcare environments by reducing time spent by staff locating remotes or adjusting TVs manually.

Certain objects and advantages of the present disclosure include an environmental audio control system to improve communication in healthcare environments by reducing distractions and miscommunication by removing sound competition.

In accordance with certain illustrative embodiments, a control device for the environmental audio control system is configured to pair with existing audio/video (A/V) systems via one or more modalities. In certain embodiments, the control device is configured to pair with a television via an IR code, similar to the function of a universal television remote. In said embodiments, the control device is configured to broadcast pre-programmed IR signal based on the TV model. A user may engage a pairing mode on the control device by pressing a designated button. The control device may cycle through pre-programmed IR codes until the TV responds. Once matched, the code is stored for that room. In certain embodiments, the control device is configured to pair with an A/V system via a BLE or RF communications protocol. In said embodiments, a healthcare IT team may pre-register the control device within a networked A/V system and, optionally, associate a user ID with the control device. The control device may be configured to automatically detect and connect to TV/speakers when entering the room upon receiving and processing a BLUETOOTH advertisement transmitted by the TV and/or speakers. In certain embodiments, the TV and/or speakers may have a unique room ID encoded in the BLUETOOTH advertisement to prevent cross-talk between devices in adjacent rooms. In certain embodiments, the environmental audio control system comprises an RFID reader for each room, which is configured to scan an RFID tag worn or carried by the user upon entry to each room. An audio controller is configured to automatically implement one or more control settings for a connected A/V system in response to the RFID reader receiving a device ID from the RFID tag.

In accordance with certain illustrative embodiments, a control device for the environmental audio control system is preprogrammed via website application or native mobile application for automatic sound management. In accordance with said embodiments, the control device may comprise a smartphone or smartwatch worn or carried by the user. The environmental audio control system may be configured to implement dynamic controls based on a proximity of the user to a patient (e.g., lower volume at 3 feet, mute volume at 1 foot). The environmental audio control system may be configured to store presets for commonly visited patient rooms. The environmental audio control system may be configured to provide firmware updates for system compatibility.

In accordance with an exemplary use case, an environmental audio control system may be installed in a hospital environment. A nurse may enter a patient room. A control device may automatically pair with a speaker and/or television located in the room. In accordance with a first mode of operation, the control device is configured to mute or lower the volume of the speaker and/or the television when the nurse enters the patient room and restore the volume to its previous level when the nurse leaves the room. In accordance with a second mode of operation, the control device may comprise a user interface (e.g., one or more buttons) configured to enable the nurse to manually mute or lower the volume of the speaker and/or the television. Once the nurse moves to another room, the control device automatically reconfigures to the new room.

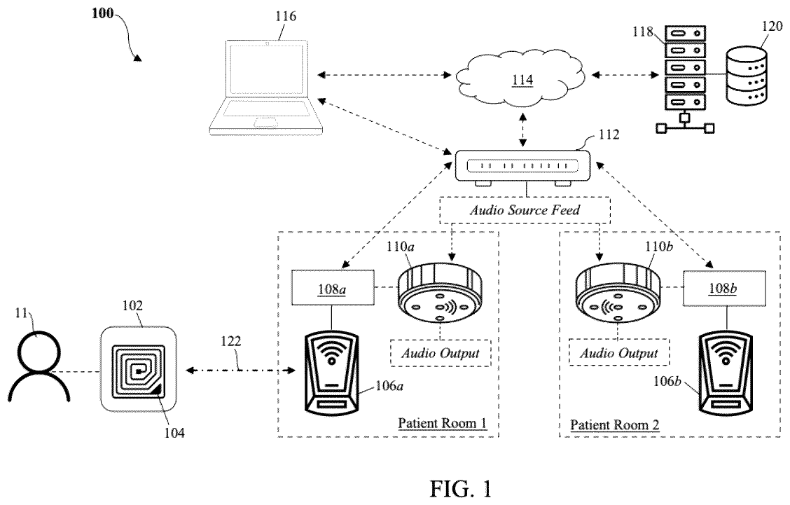

Turning now descriptively to the drawings, in which similar reference characters denote similar elements throughout the several views, FIG. 1 depicts a system architecture diagram of an embodiment of an environmental sound control system 100. In accordance with certain aspects of the present disclosure, system 100 is configured to enable proximity-based, hands-free control of an audio system in an interior environment, such as a hospital or medical office. In accordance with certain embodiments, system 100 comprises a badge 102 comprising an RFID antenna 104. Badge 102 may be worn or carried by a user 11. In certain embodiments, badge 102 may comprise an RFID tag. RFID antenna 104 may comprise a passive RFID tag. In certain embodiments, badge 102 may comprise an RFID tag used for electronic access in association with an electronic access control system. System 100 may further comprise one or more RFID reader 106a-106b. In accordance with certain implementations, a first RFID reader 106a may be installed in a first location in an interior environment (e.g., Patient Room 1) and a second RFID reader 106b may be installed in a second location in the interior environment (e.g., Patient Room 2). In certain embodiments, RFID readers 106a-106b may be permanently installed on a surface of the interior environment (e.g., a wall) and hardwired or may be portable and wireless. System 100 may further comprise one or more control modules 108a-108b. Control modules 108a-108b may be incorporated into an overall electronics assembly RFID readers 106a-106b or may comprise standalone devices communicably engaged with RFID readers 106a-106b via a system bus or other communications interface. System 100 may further comprise one or more loudspeakers 110a-110b. Loudspeakers 110a-110b may comprise powered or unpowered speakers. In certain embodiments, loudspeakers 110a-110b may be installed on a surface of the interior environment (e.g., a wall or ceiling) and may be hardwired for power and an audio source. In certain embodiments, loudspeakers 110a-110b may comprise smart speakers (e.g., Wi-Fi enabled speakers) and may be wireless.

System 100 may further comprise an audio source device 112. In embodiments wherein loudspeakers 110a-110b comprise unpowered speakers that are hardwired, audio source device 112 comprises an audio amplifier configured to provide power and an audio source feed to loudspeakers 110a-110b. In embodiments wherein loudspeakers 110a-110b comprise wireless, smart speakers, audio source device 112 comprises a Wi-Fi gateway configured to provide an audio source feed from a remote server (e.g., a music streaming service) via an Internet network 114. In accordance with certain aspects of the present disclosure, audio source device 112 may be communicably engaged with a user workstation 116 via a local area network or a wide area network (e.g., WiFi). In embodiments wherein audio source device 112 comprises an audio amplifier, user workstation 116 may comprise a radio, media server, MP3 player, or other means for providing an audio source feed to audio source device 112. User workstation 116 may comprise a centralized IT management workstation configured to control one or more building access controls for the interior environment, such as an electronic access control system. In certain embodiments, system 100 may comprise one or more networked server 118. Networked server 118 may be configured to host a remote application configured to command and control one or more operations, settings and parameters for system 100. In certain embodiments, networked server 118 may comprise an IT management server configured to control one or more IT systems for the interior environment. In certain embodiments, networked server 118 may comprise an electronic access control server configured to manage access to one or more electronic access control devices associated with the interior environment (e.g., exterior or interior access doors).

In accordance with certain aspects of the present disclosure, user 11 may interact with system 100 upon entering Patient Room 1. Upon entering Patient Room 1, RFID reader 106a may send an RF transmission to badge 102. The RF transmission may be configured to power RF antenna 104 such that RF antenna 104 is configured to transmit an RF transmission 122 back to RFID reader 106a. In embodiments wherein badge 102 comprises an active RFID tag (i.e., as opposed to a passive RFID tag), RF antenna 104 may be configured to transmit RF transmission 122 to RFID reader 106a without first receiving a transmission from RFID reader 106a. In accordance with certain embodiments, RF transmission 122 comprises a data packet encoded therein. The data packet may comprise a unique identifier for badge 102. In certain embodiments, the unique identifier may be associated with user 11 in system 100. RFID reader 106a may be configured to receive RF transmission 122 and decode the data packet. RFID reader 106a may be configured to send the decoded data packet to control module 108a via at least one system bus. Control module 108a may be configured to process the data packet to determine the unique identifier. Upon processing the data packet, control module 108a may be configured to execute one or more steps or operations to reduce or mute a volume level of an audio output at loudspeaker 110a. In certain embodiments, control module 108a and RFID reader 106a may be integrated into a wall controller for a networked audio system. In certain embodiments, the wall controller may be configured to control multiple zones of audio, select audio sources, adjust volume, and perform other functions such as scene recall, message recall, routine recall, GPO control, and bell schedules. In accordance with certain embodiments, system 100 is configured to maintain a volume level of an audio output at loudspeaker 110b while reducing or muting the volume at loudspeaker 110a. In accordance with certain aspects of the present disclosure, RFID receiver 106a is configured to continuously send/receive an RF transmission to determine a proximity of badge 102. In accordance with certain aspects of the present disclosure, when user 11 leaves Patient Room 1, RFID receiver 106a is configured to determine that RF antenna 104 is no longer in range (i.e., RFID receiver 106a is no longer receiving RF transmission 122). Upon sensing that RF antenna 104 is no longer in range, RFID receiver 106a is configured to send a signal to control module 108a. Control module 108a is configured to process the signal and unmute or restore the volume level of the audio output at loudspeaker 110a to its previous level or to a preset level. In accordance with certain aspects of the present disclosure, a volume level of the audio output at loudspeaker 110b remains unchanged during the interaction between badge 102 and RFID receiver 106a.

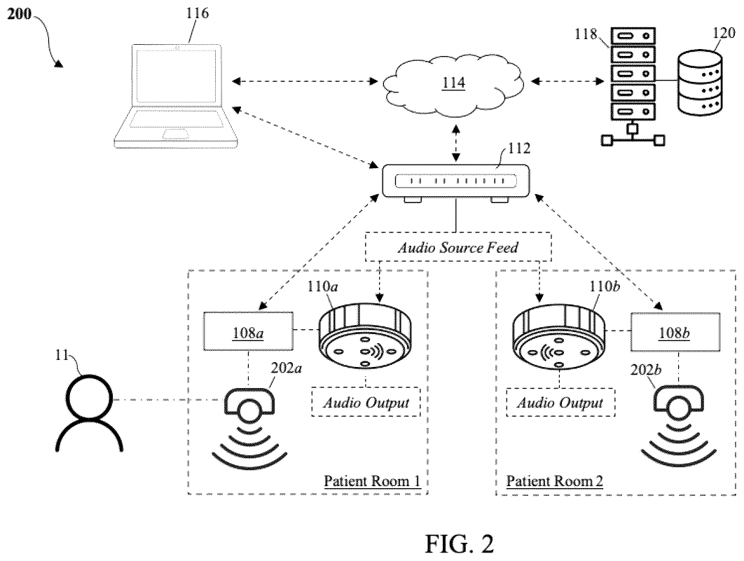

Referring now to FIG. 2, a system architecture diagram of an environmental sound control system 200 is shown. In accordance with certain aspects of the present disclosure, system 200 comprises an alternative embodiment to system 100, as shown and described in FIG. 1. In accordance with certain aspects of the present disclosure, system 200 comprises one or more sensor devices 202a-202b. Sensor devices 202a-202b may comprise one or more acoustic transducer (e.g., microphone), digital camera, optical sensor, ultrasonic sensor, imaging sensor, infrared sensor, and passive infrared sensor and the like. For the sake of brevity, description made in reference to sensor device 202a shall apply equally to sensor device 202b. In certain embodiments, sensor device 202a is communicably engaged with control module 108a via a system bus or other communications interface. In certain embodiments, sensor device 202a and control module 108a are integrally assembled into a single unit. The single unit may comprise a wall controller for a networked audio system. In certain embodiments, the wall controller may be configured to control multiple zones of audio, select audio sources, adjust volume, and perform other functions such as scene recall, message recall, routine recall, GPO control, and bell schedules. In other embodiments, sensor device 202a may be separate from control module 108a.

In accordance with certain aspects of the present disclosure, user 11 may interact with system 200 upon entering Patient Room 1. Upon entering Patient Room 1, sensor 202a may detect the presence of user 11 via one or more sensor input signal (e.g., based on the sensor type). Sensor 202a may communicate the sensor input signal to control module 108a via the system bus or communications interface. Control module 108a may process the sensor input signal to determine the presence of user 11 in Patient Room 1. In certain embodiments, control module 108a may also execute one or more steps or operations to determine the identity of user 11. Upon processing the sensor input signal and, optionally, determining the identity of user 11, control module 108a may be configured to execute one or more steps or operations to reduce or mute a volume level of an audio output at loudspeaker 110a. In accordance with certain aspects of the present disclosure, user 11 may further interact with system 200 upon exiting Patient Room 1. Upon exiting Patient Room 1, sensor 202a may detect the movement/absence of user 11 via one or more sensor input signal (e.g., based on the sensor type). Sensor 202a may communicate the sensor input signal to control module 108a via the system bus or communications interface. Control module 108a may process the sensor input signal to determine the absence of user 11 from Patient Room 1. Upon processing the sensor input signal, control module 108a may be configured to execute one or more steps or operations to unmute and/or restore the volume level of the audio output at loudspeaker 110a to its previous level or a preset level.

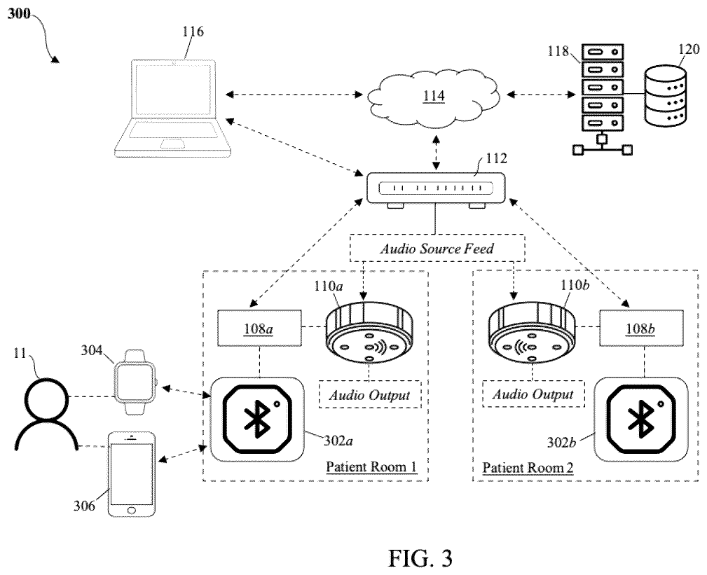

Referring now to FIG. 3, a system architecture diagram of an environmental sound control system 300 is shown. In accordance with certain aspects of the present disclosure, system 300 comprises an alternative embodiment of system 200, as shown and described in FIG. 2, and an alternative embodiment of system 100, as shown and described in FIG. 1. In accordance with certain aspects of the present disclosure, system 300 comprises beacon devices 302a-302b and user devices 304-306. User devices 304-306 may comprise, for example, a smartwatch 304 and a smart phone 306. User devices 304-306 may further comprise wearable activity trackers, personal computing devices, smart jewelry, smart glasses, wearable earpieces and the like. Beacon devices 302a-302b may comprise BLUETOOTH beacons configured to receive a BLUETOOTH advertisement from user devices 304-306. For the sake of brevity, description made in reference to beacon device 302a shall apply equally to beacon device 302b. In certain embodiments, beacon device 302a is communicably engaged with control module 108a via a system bus or other communications interface. In certain embodiments, beacon device 302a and control module 108a are integrally assembled into a single unit. The single unit may comprise a wall controller for a networked audio system. In certain embodiments, the wall controller may be configured to control multiple zones of audio, select audio sources, adjust volume, and perform other functions such as scene recall, message recall, routine recall, GPO control, and bell schedules. In other embodiments, beacon device 302a may comprise a separate device from control module 108a.

In accordance with certain aspects of the present disclosure, user 11 may interact with system 300 upon entering Patient Room 1. Upon entering Patient Room 1, beacon device 302a may receive a BLUETOOTH advertisement from a smartwatch 304 and/or a smart phone 306 associated with user 11. In accordance with certain embodiments, the BLUETOOTH advertisement sent from smartwatch 304 and/or a smart phone 306 comprises a data packet encoded therein. The data packet may comprise a unique device identifier associated with smartwatch 304 and/or a smart phone 306. In certain embodiments, the unique device identifier may be associated with user 11 in system 300. Beacon device 302a is configured to receive the BLUETOOTH advertisement and decode the data packet. Beacon device 302a is configured to send the decoded data packet to control module 108a via at least one system bus. Control module 108a may be configured to process the data packet to determine the unique device identifier. Upon processing the data packet, control module 108a may be configured to execute one or more steps or operations to reduce or mute a volume level of the audio output at loudspeaker 110a. In accordance with certain embodiments, system 300 is configured to maintain a volume level of the audio output at loudspeaker 110b while reducing or muting the volume at loudspeaker 110a. In accordance with certain aspects of the present disclosure, beacon device 302a is configured to continuously send/receive an RF transmission (i.e., according to a BLUETOOTH protocol) to determine a proximity of smartwatch 304 and/or a smart phone 306. In accordance with certain aspects of the present disclosure, when user 11 leaves Patient Room 1, beacon device 302a is configured to determine that smartwatch 304 and/or a smart phone 306 is no longer in range (i.e., beacon device 302a is no longer receiving the BLUETOOTH advertisement and/or has lost a BLUETOOTH connection). Upon sensing that smartwatch 304 and/or a smart phone 306 is no longer in range, beacon device 302a is configured to send a signal to control module 108a. Control module 108a is configured to process the signal and unmute or restore the volume level of the audio output at loudspeaker 110a to its previous level or to a preset level. In accordance with certain aspects of the present disclosure, a volume level of the audio output at loudspeaker 110b remains unchanged during the interaction between smartwatch 304 and/or a smart phone 306, beacon device 302a and control module 108a.

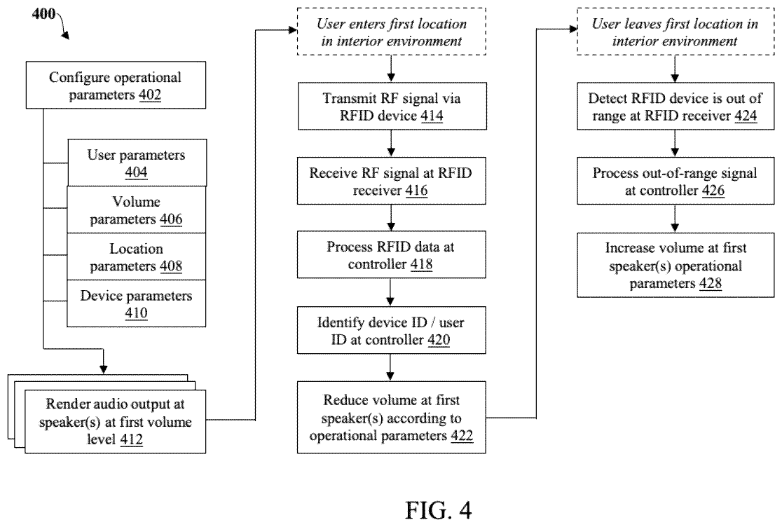

Referring now to FIG. 4, a process flow diagram of a routine 400 for an environmental sound control system is shown. In accordance with certain aspects of the present disclosure, routine 400 may be implemented within system 100, as shown and described in FIG. 1. The operations in routine 400 may be performed in the order presented, in a different order, or simultaneously. Further, in some exemplary embodiments, some of the operations may be omitted, added, modified, skipped, or the like without departing from the scope of the invention. In accordance with certain aspects of the present disclosure, routine 400 comprises one or more steps or operations 402-428 for automatically modifying a volume level of an audio output at a first speaker in an interior environment according to a user's proximity to the first speaker.

In accordance with certain aspects of the present disclosure, routine 400 may comprise one or more steps or operations for configuring one or more operational parameters of the environmental sound control system (Step 402). The one or more operational parameters may be configurable by a user (e.g., via at least one user interface of a user application) or the parameters may be encoded in firmware by the manufacturer. In certain embodiments, one or more operational parameters may include one or more user parameters 404, volume parameters 406, location parameters 408 and device parameters 410. User parameters 404 may comprise one or more parameters for assigning a user role or user identifier to one or more user. The user role may be associated with one or more system permissions and/or preset operations for the user role. The user identifier may be a unique identifier for identifying a specific user. In certain embodiments, specific system controls may be assigned to specific users based on the user identifier parameters. Volume parameters 406 may comprise logical parameters for modifying the volume at one or more speakers. For example, volume parameters 406 may include parameters for muting a speaker or reducing the volume of the speaker by a predetermined amount or to a predetermined level (e.g., reduce volume to 10% of max volume or reduce existing volume level by 70%). Specific volume parameters may be applied to the user parameters. Location parameters 408 may comprise logical parameters for assigning user parameters, volume parameters and device parameters to specific locations in an interior environment. For example, speakers in a first location, such as a patient waiting room, may be assigned a first location parameter and speakers in a second location, such as a patient treatment room, may be assigned a second location parameter. For example, location parameters 408 may be configured such that a volume level for a first speaker located in the first location is reduced by 50% when a first user enters the first location and parameters for the second location may be configured such that a volume level for a second speaker located in the second location is muted when the first user enters the second location. Device parameters 410 may comprise parameters for specific devices in the system; for example, specific speakers and/or user devices, such as RFID tags and computing devices (e.g., smartphones, wearable devices, etc.). In accordance with certain aspects of the present disclosure, operational parameters 404-410 may be stored in an application database for the system and/or provisioned on the firmware of one or more system devices. In certain embodiments, system devices may be provisioned via one or more over-the-air updates.

Routine 400 may comprise one or more steps or operations for rendering an audio output at a plurality of speakers in an interior environment (Step 412). The audio output may be rendered at a first volume level at each speaker in the plurality of speakers. In certain embodiments, the volume level may be controlled by a system user, such as a nurse or office administrator. In other embodiments, the volume level may be controlled by an occupant of the interior environment, such as a patient. In accordance with certain aspects of the present disclosure, a plurality of operations of routine 400 may be instantiated upon a user entering a first location in the interior environment (e.g., a patient treatment room), wherein the user is carrying or wearing an RFID device, such as an RFID tag. The RFID device may comprise badge 102, as shown and described in FIG. 1. In accordance with certain embodiments, routine 400 may comprise one or more steps or operations for transmitting an RF signal via the RFID device (Step 414). The RFID device may comprise an active RFID device (i.e., with a battery) or a passive RFID device (i.e., without a battery). In embodiments that utilize a passive RFID device, step 414 may comprise a step for receiving an RF transmission from an RF transmitter to power an antenna of the RFID device to send a return transmission. In accordance with certain embodiments, routine 400 may proceed by executing one or more steps or operations for receiving the RF transmission from the RFID device at an RFID receiver (Step 416). The RFID receiver may comprise RFID reader 106a, as shown and described in FIG. 1. In certain embodiments, the RF transmission may comprise a data packet comprising a unique identifier encoded therein. The unique identifier may be configured to identify a user or a device within the system. In certain embodiments, step 416 may comprise one or more steps or operations for decoding the data packet and providing the decoded data packet to a controller. The controller may comprise control module 108a, as shown and described in FIG. 1. Routine 400 may comprise one or more steps or operations for processing the RFID data according to one or more data processing framework (Step 418). Routine 400 may comprise one or more steps or operations for identifying a device ID and/or a user ID according to the data processing framework (Step 420). In accordance with certain aspects of the present disclosure, routine 400 may proceed by executing one or more steps or operations for reducing a volume level of the audio output at a first speaker according to RFID data and the operational parameters (Step 422). In certain embodiments, step 422 may comprise one or more operations for muting the audio output at the first speaker.

In accordance with certain aspects of the present disclosure, one or more steps or operations of routine 400 may be instantiated upon the user leaving the first location in the interior environment. In accordance with certain aspects of the present disclosure, the RFID receiver may be configured to continuously receive the RFID signal from the RFID receiver while the user is present at the first location in the interior environment. Once the user leaves the first location in the interior environment, routine 400 may comprise one or more steps or operations for detecting that the RFID device is out of range of the RFID receiver (Step 424). The operations of step 424 may be accomplished through one or more conventional methods through which RFID protocols establish that a device is out of range. Step 424 may comprise one or more operations for sending a signal or other data input to the controller to indicate the RFID device is out of range. Routine 400 may proceed by executing one or more steps or operations for processing the out-of-range signal at the controller (Step 426). Routine 400 may comprise one or more steps or operations for increasing the volume at the first speaker in response to an output of step 426 according to the operational parameters (Step 428). The operational parameters may be configured to restore the volume of the audio output to a prior level. Alternatively, the operational parameters may be configured to increase the volume to a preset level.

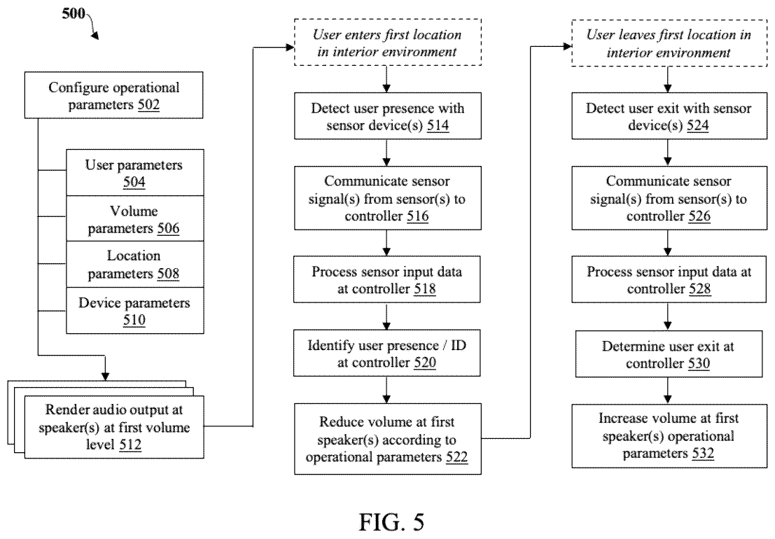

Referring now to FIG. 5, a process flow diagram of a routine 500 for an environmental sound control system is shown. In accordance with certain aspects of the present disclosure, routine 500 may be implemented within system 200, as shown and described in FIG. 2. The operations in routine 500 may be performed in the order presented, in a different order, or simultaneously. Further, in some exemplary embodiments, some of the operations may be omitted, added, modified, skipped, or the like without departing from the scope of the invention. In accordance with certain aspects of the present disclosure, routine 500 comprises one or more steps or operations 502-532 for automatically modifying a volume level of an audio output at a first speaker in an interior environment according to a user's proximity to the first speaker.

In accordance with certain aspects of the present disclosure, routine 500 may comprise one or more steps or operations for configuring one or more operational parameters of the environmental sound control system (Step 502). The one or more operational parameters may be configurable by a user (e.g., via at least one user interface of a user application) or the parameters may be encoded in firmware by the manufacturer. In certain embodiments, one or more operational parameters may include one or more user parameters 504, volume parameters 506, location parameters 508 and device parameters 510. User parameters 504 may comprise one or more parameters for assigning a user role or user identifier to one or more user. The user role may be associated with one or more system permissions and/or preset operations for the user role. The user identifier may be a unique identifier for identifying a specific user. In certain embodiments, specific system controls may be assigned to specific users based on the user identifier parameters. Volume parameters 506 may comprise logical parameters for modifying the volume at one or more speakers. For example, volume parameters 506 may include parameters for muting a speaker or reducing the volume of the speaker by a predetermined amount or to a predetermined level (e.g., reduce volume to 10% of max volume or reduce existing volume level by 70%). Specific volume parameters may be applied to the user parameters. Location parameters 508 may comprise logical parameters for assigning user parameters, volume parameters and device parameters to specific locations in an interior environment. For example, speakers in a first location, such as a patient waiting room, may be assigned a first location parameter and speakers in a second location, such as a patient treatment room, may be assigned a second location parameter. For example, location parameters 508 may be configured such that a volume level for a first speaker located in the first location is reduced by 50% when a first user enters the first location and parameters for the second location may be configured such that a volume level for a second speaker located in the second location is muted when the first user enters the second location. Device parameters 510 may comprise parameters for specific devices in the system; for example, specific speakers and/or user devices, such as RFID tags and computing devices (e.g., smartphones, wearable devices, etc.). In accordance with certain aspects of the present disclosure, operational parameters 504-510 may be stored in an application database for the system and/or provisioned on the firmware of one or more system devices. In certain embodiments, system devices may be provisioned via one or more over-the-air updates.

Routine 500 may comprise one or more steps or operations for rendering an audio output at a plurality of speakers in an interior environment (Step 512). The audio output may be rendered at a first volume level at each speaker in the plurality of speakers. In certain embodiments, the volume level may be controlled by a system user, such as a nurse or office administrator. In other embodiments, the volume level may be controlled by an occupant of the interior environment, such as a patient. In accordance with certain aspects of the present disclosure, a plurality of operations of routine 500 may be instantiated upon a user entering a first location in the interior environment (e.g., a patient treatment room). In accordance with certain aspects of the present disclosure, routine 500 may comprise one or more operations for detecting the presence of the user via one or more sensor devices. In accordance with certain embodiments, the one or more sensor devices may comprise sensor 202a, as shown and described in FIG. 2. Routine 500 may proceed by performing one or more steps or operations for communicating one or more sensor input signal(s) from the one or more sensor devices to the controller (Step 516). The controller may comprise control module 108a, as shown and described in FIG. 1. Routine 500 may proceed by performing one or more steps or operations for processing the sensor input data at the controller according to at least one data processing framework (Step 518). Routine 500 may proceed by performing one or more steps or operations for identifying the presence of the user in the first location of the interior environment according to the sensor input data (Step 520). In certain embodiments, step 520 may comprise one or more steps or operations for determining a user identity according to the sensor input data. In certain embodiments, step 520 may comprise one or more image recognition steps or voice recognition steps to determine the user identity. Routine 500 may proceed by executing one or more steps or operations for muting or reducing the volume of the audio output at the first speaker according to the operational parameters (Step 522).

In accordance with certain aspects of the present disclosure, one or more additional steps of routine 500 are instantiated upon the user leaving the first location in the interior environment. In accordance with certain embodiments, routine 500 comprises one or more steps or operations for detecting the motion of the user when leaving the first location in the interior environment with the one or more sensor devices (Step 524). Routine 500 may comprise one or more steps or operations for communicating one or more sensor input signal from the one or more sensors to the controller in response to the one or more sensor devices detecting the motion of the user when leaving the first location in the interior environment (Step 526). Routine 500 may comprise one or more steps or operations for processing the sensor input data according to the data processing framework (Step 528). The data processing framework may comprise one or more processing steps to determine that the user has exited the first location; for example, measuring a sensor signal at a doorway or using an image processing framework to determine that the user is no longer present in the first location (Step 530). In accordance with certain aspects of the present disclosure, routine 500 may comprise one or more steps or operations for increasing the volume at the first speaker in response to an output of step 530, i.e., according to the operational parameters (Step 532). The operational parameters may be configured to restore the volume of the audio output to a prior level. Alternatively, the operational parameters may be configured to increase the volume to a preset level.

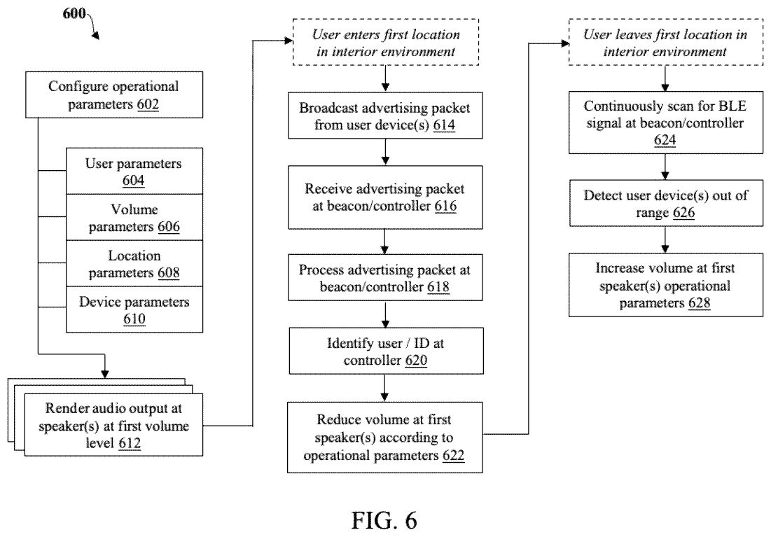

Referring now to FIG. 6, a process flow diagram of a routine 600 for an environmental sound control system is shown. In accordance with certain aspects of the present disclosure, routine 600 may be implemented within system 300, as shown and described in FIG. 3. The operations in routine 600 may be performed in the order presented, in a different order, or simultaneously. Further, in some exemplary embodiments, some of the operations may be omitted, added, modified, skipped, or the like without departing from the scope of the invention. In accordance with certain aspects of the present disclosure, routine 600 comprises one or more steps or operations 602-628 for automatically modifying a volume level of an audio output at a first speaker in an interior environment according to a user's proximity to the first speaker.

In accordance with certain aspects of the present disclosure, routine 600 may comprise one or more steps or operations for configuring one or more operational parameters of the environmental sound control system (Step 602). The one or more operational parameters may be configurable by a user (e.g., via at least one user interface of a user application) or the parameters may be encoded in firmware by the manufacturer. In certain embodiments, the one or more operational parameters may include one or more user parameters 604, volume parameters 606, location parameters 608 and device parameters 610. User parameters 604 may comprise one or more parameters for assigning a user role or user identifier to one or more user. The user role may be associated with one or more system permissions and/or preset operations for the user role. The user identifier may be a unique identifier for identifying a specific user. In certain embodiments, specific system controls may be assigned to specific users based on the user identifier parameters. Volume parameters 606 may comprise logical parameters for modifying the volume at one or more speakers. For example, volume parameters 606 may include parameters for muting a speaker or reducing the volume of the speaker by a predetermined amount or to a predetermined level (e.g., reduce volume to 10% of max volume or reduce existing volume level by 70%). Specific volume parameters may be applied to the user parameters. Location parameters 608 may comprise logical parameters for assigning user parameters, volume parameters and device parameters to specific locations in an interior environment. For example, speakers in a first location, such as a patient waiting room, may be assigned a first location parameter and speakers in a second location, such as a patient treatment room, may be assigned a second location parameter. For example, location parameters 608 may be configured such that a volume level for a first speaker located in the first location is reduced by 50% when a first user enters the first location and parameters for the second location may be configured such that a volume level for a second speaker located in the second location is muted when the first user enters the second location. Device parameters 610 may comprise parameters for specific devices in the system; for example, specific speakers and/or user devices, such as RFID tags and computing devices (e.g., smartphones, wearable devices, etc.). In accordance with certain aspects of the present disclosure, operational parameters 604-610 may be stored in an application database for the system and/or provisioned on the firmware of one or more system devices. In certain embodiments, system devices may be provisioned via one or more over-the-air updates.

Routine 600 may comprise one or more steps or operations for rendering an audio output at a plurality of speakers in an interior environment (Step 612). The audio output may be rendered at a first volume level at each speaker in the plurality of speakers. In certain embodiments, the volume level may be controlled by a system user, such as a nurse or office administrator. In other embodiments, the volume level may be controlled by an occupant of the interior environment, such as a patient. In accordance with certain aspects of the present disclosure, a plurality of operations of routine 600 may be instantiated upon a user entering a first location in the interior environment (e.g., a patient treatment room). In accordance with certain aspects of the present disclosure, routine 600 may comprise one or more operations for broadcasting an advertising packet from one or more user devices (Step 614). The advertising packet may comprise a BLUETOOTH advertisement comprising encoded data for establishing a communications protocol between the one or more user devices and a beacon device. The one or more user devices may comprise user devices 304-306 as shown and described in FIG. 3. Routine 600 may further comprise one or more steps or operations for receiving the advertising packet at the beacon device (Step 616). The beacon device may comprise a BLUETOOTH beacon and may be embodied as beacon device 302a, as shown and described in FIG. 3. In certain embodiments, the beacon device may comprise an RF receiver/transceiver that is communicably engaged with a controller. The controller may comprise control module 108a, as shown and described in FIG. 3. In accordance with certain embodiments, step 616 may comprise one or more steps or operations for receiving the advertising packet at the controller. Routine 600 may comprise one or more steps or operations for processing the advertising packet at the beacon device and/or the controller (Step 618). Step 618 may comprise one or more steps or operations for decoding the advertising packet at the beacon device. Routine 600 may comprise one or more steps or operations for processing the advertising data at the controller to identify a user ID and/or device ID (Step 620). Routine 600 may comprise one or more steps or operations for processing the user ID and/or device ID according to the operational parameters to mute or reduce a volume level of the audio output at the speaker(s) in the first location of the interior environment (Step 622).

In accordance with certain aspects of the present disclosure, one or more steps or operations of routine 600 may be instantiated upon the user leaving the first location in the interior environment. In accordance with certain aspects of the present disclosure, the beacon device may be configured to continuously receive a BLUETOOTH advertisement from the user devices and/or establish a BLUETOOTH connection with the user devices while the user is present at the first location in the interior environment (Step 624). Once the user leaves the first location in the interior environment, routine 600 may comprise one or more steps or operations for detecting that the user devices are out of range or outside of a specified barrier (Step 626). The operations of step 626 may be accomplished through one or more conventional BLUETOOTH protocols for establishing that a device is out of range or outside of a specified area. Step 626 may comprise one or more operations for sending a signal or other data input from the beacon device to the controller to indicate the user device is out of range. Routine 600 may proceed by executing one or more steps or operations for processing the out-of-range signal at the controller at step 626. In response, routine 600 may comprise one or more steps or operations for increasing the volume at the first speaker according to the operational parameters (Step 628). The operational parameters may be configured to restore the volume of the audio output to a prior level. Alternatively, the operational parameters may be configured to increase the volume to a preset level.

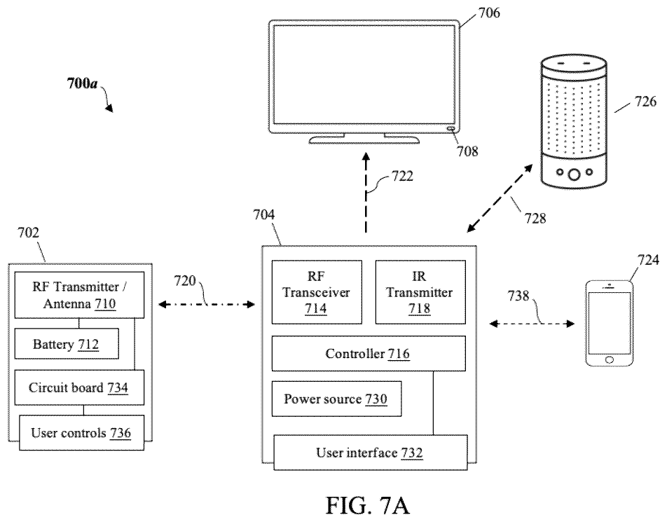

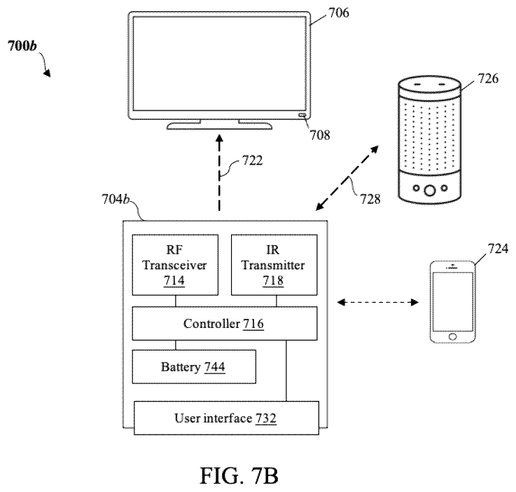

FIGS. 7A-7B depict system architecture diagrams of embodiments of an environmental sound control system 700a and 700b. Referring first to FIG. 7A, system 700a comprises a wireless, hands-free system for automatically controlling a volume level of a television, smart speaker and/or other smart appliance within a specified range. In accordance with certain aspects of the present disclosure, system 700a comprises a transmitter unit 702 and a control unit 704. Transmitter unit 702 may comprise an RF antenna/transmitter 710, a battery 712, a circuit board 734, and, optionally, one or more user controls 736. Control unit 704 may comprise an RF transceiver 714, an IR transmitter 718, a controller 716, a power source 730 and a user interface 732. In accordance with certain embodiments, RF transmitter 710 may comprise an active or passive RFID transmitter. In certain embodiments, RF transmitter 710 may comprise a wireless communications chipset (e.g., BLUETOOTH). User controls 736 may comprise one or more button configured to command one or more functions via circuit board 734 (e.g., volume up/down, mute, power). RF transceiver 714 may comprise an RFID reader. In certain embodiments, RF transceiver may comprise a BLUETOOTH chipset. Power source 730 may comprise a battery or a wired power supply. Controller 716 may be configured to command the operations of RF transceiver 714 and IR transmitter 718. User interface 732 may comprise one or more buttons configured to command one or more operations for controller 716; for example, volume up/down, mute, source selection, BLUETOOTH pairing, IR pairing, power, etc. In accordance with certain embodiments, transmitter unit 702 may configured to send an RF transmission 720 to control unit 704. RF transmission 720 may comprise a BLUETOOTH communications protocol. In certain embodiments, system 700a may further comprise a client device (e.g., a smart phone) 724. Client device 724 may be communicably engaged with control unit 704 via a BLUETOOTH connection 738. Client device 724 may comprise a Web-based or native application configured to configure one or more operational settings of control unit 704 and/or control one or more functions of control unit 704.

In accordance with certain aspects of the present disclosure, system 700a may further comprise a TV 706 and a smart speaker 726. In certain embodiments, smart speaker 726 may comprise another smart appliance configured to be communicably engaged in an Internet-of-Things (IoT) framework. TV 706 may comprise an IR receiver 708 configured to receive an IR signal configured to command one or more operations of TV 706. Smart speaker 726 may comprise a BLUETOOTH enabled speaker configured to be communicably engaged with control unit 704 via a BLUETOOTH connection 728. In accordance with certain aspects of the present disclosure, control unit 704 is configured to send an IR signal 722 to IR receiver 708 via IR transmitter 718.

In accordance with an exemplary use case of system 700a, a user may carry or wear transmitter unit 702. Control unit 704 may be placed in a location of an interior environment (e.g., a hospital room) in proximity to TV 706 and/or smart speaker 726. In accordance with certain embodiments, control unit 704 is placed within a line of sight to IR receiver 708. Control unit 704 may be paired with TV 706 using one or more known IR pairing methods (e.g., similar to a universal TV remote). Control unit 704 may be configured to automatically pair with smart speaker 726 upon receiving a BLUETOOTH advertisement from smart speaker 726. In accordance with the exemplary use case, the user may enter a location in the interior environment in proximity to control unit 704. Once in proximity to control unit 704, RF transmitter 710 may be configured to send an RF signal to RF transceiver 714. RF transceiver 714 may be configured to process a data packet from the RF signal via controller 716 to identify transmitter unit 702. Upon identifying transmitter unit 702, controller 716 is configured to command IR transmitter 718 to send an IR transmission 722 to IR receiver 708 to mute or lower the volume of the television. Alternatively, or additionally, controller 716 is configured to send a command signal to smart speaker 726 via BLUETOOTH connection 728 to mute or lower the volume of an audio output at smart speaker 726. In accordance with certain embodiments, controller 716 is configured to determine when transmitter unit 702 is out of range and/or outside of a specified distance from control unit 704 (e.g., based on a signal strength of RF transmission 720). Upon determining transmitter unit 702 is out of range and/or outside of a specified distance from control unit 704, controller 716 may be configured to command IR transmitter 718 to send an IR transmission 722 to IR receiver 708 to unmute or raise the volume of the television to a prior level or preset level. Alternatively, or additionally, controller 716 may be configured to send a command signal to smart speaker 726 via BLUETOOTH connection 728 to unmute or raise the volume of the television to a prior level or preset level.

Referring now to FIG. 7B (with reference to FIG. 7A), an alternative embodiment of system 700a is shown. As shown in FIG. 7B, system 700b is substantially the same as system 700a with the exception of the elimination of transmitter unit 702. Control unit 704b may comprise the addition of a battery 744 such that control unit 704b is portable. In accordance with certain aspects of the present disclosure, a user may carry control unit 704b between rooms in an interior environment. In accordance with certain embodiments, TV 706 may comprise a smart TV with BLUETOOTH connectivity. Control unit 704b may be configured to recognize a device ID from a BLUETOOTH advertisement from TV 706 and smart speaker 726. Control unit 704b may be configured to automatically pair with smart speaker 726 upon receiving a BLUETOOTH advertisement from smart speaker 726. Upon recognizing the device ID from TV 706, controller 716 is configured to command IR transmitter 718 to send an IR transmission 722 to IR receiver 708 to mute or lower the volume of the television. Alternatively, or additionally, controller 716 is configured to send a command signal to smart speaker 726 via BLUETOOTH connection 728 to mute or lower the volume of an audio output at smart speaker 726. In accordance with certain embodiments, controller 716 is configured to determine when TV 706 and/or smart speaker 726 is out of range and/or outside of a specified distance from control unit 704b (e.g., based on a signal strength of an RF transmission). Upon determining TV 706 and/or smart speaker 726 are out of range and/or outside of a specified distance from control unit 704, controller 716 may be configured to command IR transmitter 718 to send an IR transmission 722 to IR receiver 708 to unmute or raise the volume of the television to a prior level or preset level. Alternatively, or additionally, controller 716 may be configured to send a command signal to smart speaker 726 via BLUETOOTH connection 728 to unmute or raise the volume of the television to a prior level or preset level.

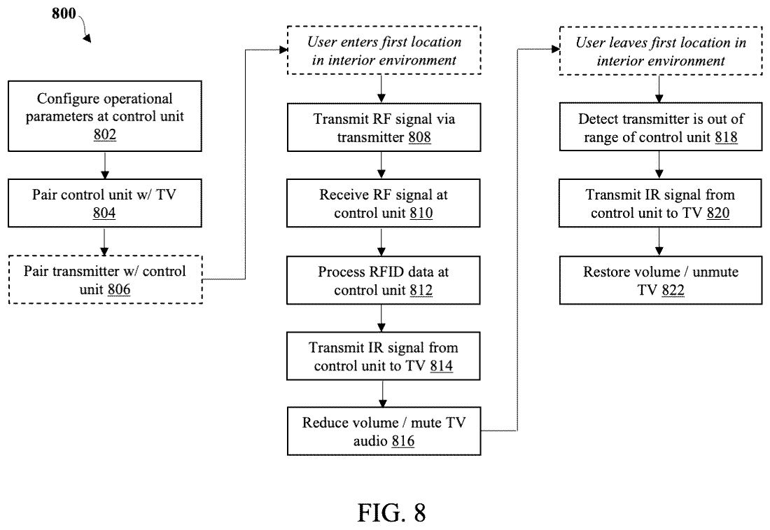

Referring now to FIG. 8, a process flow diagram of a routine 800 for an environmental sound control system is shown. In accordance with certain aspects of the present disclosure, routine 800 may be implemented within system 700a of FIG. 7A and/or system 700b of FIG. 7B. The operations in routine 800 may be performed in the order presented, in a different order, or simultaneously. Further, in some exemplary embodiments, some of the operations may be omitted, added, modified, skipped, or the like without departing from the scope of the invention. In accordance with certain aspects of the present disclosure, routine 800 comprises one or more steps or operations 802-822 for automatically modifying a volume level of a television according to a user's proximity to the television.

In accordance with certain aspects of the present disclosure, routine 800 may comprise one or more steps or operations for configuring one or more operational parameters at a control unit of the system (Step 802). The control unit may comprise control unit 704, as shown in FIG. 7A. The operational parameters may include such operational parameters as those described herein. Routine 800 may proceed by executing one or more steps or operations for pairing the control unit with the TV via an IR pairing method (Step 804). The IR pairing method may be substantially the same as employed by universal television remotes. In system embodiments comprising a separate transmitter unit (e.g., transmitter unit 702 as shown in FIG. 7A), routine 800 may comprise one or more steps or operations for pairing the transmitter unit with the control unit (Step 806). In accordance with certain aspects of the present disclosure, one or more steps or operations of routine 800 are instantiated upon the user entering a first location of an interior environment in proximity to the TV (i.e., a hospital room). Routine 800 may proceed by executing one or more steps or operations for transmitting an RF signal from the transmitter unit to the control unit (Step 808) and receiving the RF signal at the control unit (Step 810). Routine 800 may comprise one or more steps or operations for processing RFID data at the control unit (Step 812) to identify a device ID or user ID. In response to processing the RFID data at the control unit, routine 800 may proceed by executing one or more steps or operations for transmitting an IR signal from the control unit to the TV (Step 814) to mute or lower a volume level of the TV audio (Step 816). In accordance with certain aspects of the present disclosure, one or more steps or operations of routine 800 are instantiated upon a user leaving the first location in the interior environment. Routine 800 may comprise one or more steps or operations for detecting that the transmitter is out of range of the control unit (Step 818). Upon detecting that the transmitter is out of range of the control unit, routine 800 may execute one or more steps or operations for transmitting an IR signal from the control unit to the TV (Step 820) to unmute or raise the volume level of the TV audio to a prior or preset level (Step 822).

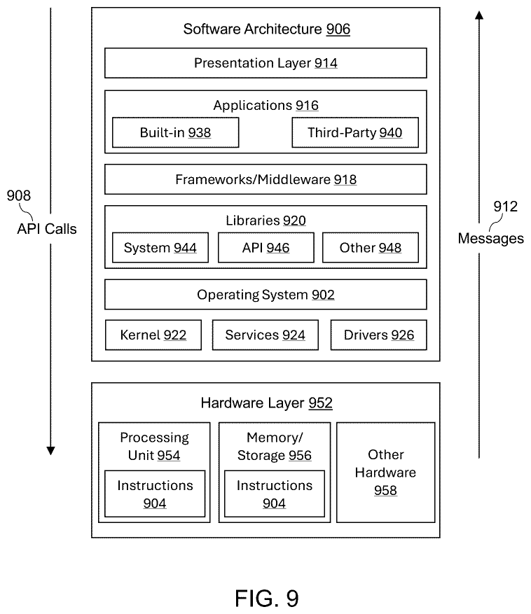

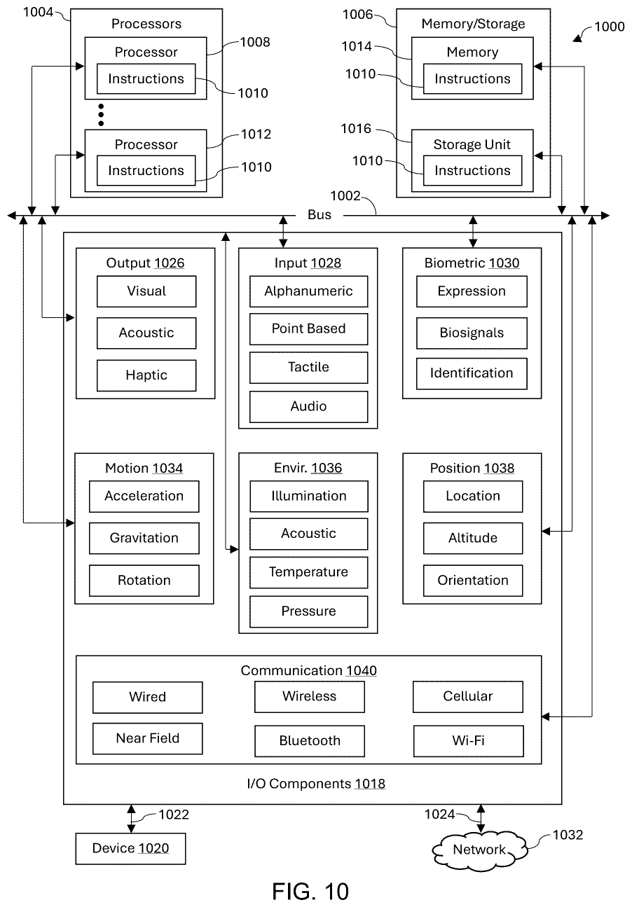

FIG. 9 is a block diagram illustrating an exemplary software architecture 906, which may be used in conjunction with various hardware architectures herein described. FIG. 9 is a non-limiting example of a software architecture, and it will be appreciated that many other architectures may be implemented to facilitate the functionality described herein. The software architecture 906 may execute on hardware such as machine 1000 of FIG. 10 that includes, among other things, processors 1004, memory 1014, and I/O components 1018. A representative hardware layer 952 is illustrated and can represent, for example, the machine 1000 of FIG. 10. The representative hardware layer 952 includes a processing unit 954 having associated executable instructions 904. Executable instructions 904 represent the executable instructions of the software architecture 906, including implementation of the methods, components and so forth described herein. The hardware layer 952 also includes memory or storage modules memory/storage 956, which also have executable instructions 904. The hardware layer 952 may also comprise other hardware 958.

As used herein, the term “component” may refer to a device, physical entity or logic having boundaries defined by function or subroutine calls, branch points, application program interfaces (APIs), or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions.

Components may constitute either software components (e.g., code embodied on a machine-readable medium) or hardware components. A “hardware component” is a tangible unit capable of performing certain operations and may be configured or arranged in a certain physical manner. In various exemplary embodiments, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations.

A hardware component may be a special-purpose processor, such as a Field-Programmable Gate Array (FPGA) or an Application Specific Integrated Circuit (ASIC). A hardware component may also include programmable logic or circuitry that is temporarily configured by software to perform certain operations. For example, a hardware component may include software executed by a processor or other programmable processor. Once configured by such software, hardware components become specific machines (or specific components of a machine) uniquely tailored to perform the configured functions and are no longer processors. It will be appreciated that the decision to implement a hardware component mechanically, in dedicated and permanently configured circuitry, or in temporarily configured circuitry (e.g., configured by software) may be driven by cost and time considerations.

A processor may be, or include, any circuit, circuitry, or virtual circuit (a physical circuit emulated by logic executing on an actual processor) that manipulates data values according to control signals (e.g., “commands”, “op codes”, “machine code”, etc.) and which produces corresponding output signals that are applied to operate a machine. A processor may, for example, be a Central Processing Unit (CPU), a Reduced Instruction Set Computing (RISC) processor, a Complex Instruction Set Computing (CISC) processor, a Graphics Processing Unit (GPU), a Digital Signal Processor (DSP), an Application Specific Integrated Circuit (ASIC), a Radio-Frequency Integrated Circuit (RFIC) or any combination thereof. A processor may further be a multi-core processor having two or more independent processors (sometimes referred to as “cores”) that may execute instructions contemporaneously. The processor as used herein may be a hardware component, which is in at least one of the devices, systems, servers and the like. The processor may include multiple cores and may be spread across multiple devices. The processor includes circuitry to execute instructions relating to the methods and structures described herein for determining relationships and outputting relationship data that is used by various devices and their users.

Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering embodiments in which hardware components are temporarily configured (e.g., programmed), each of the hardware components need not be configured or instantiated at any one instance in time. For example, where a hardware component comprises a processor configured by software to become a special-purpose processor, the processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In embodiments in which multiple hardware components are configured or instantiated at different times, communications between such hardware components may be achieved, for example, through the storage and retrieval of information in memory structures to which the multiple hardware components have access.

For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components.

Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an Application Program Interface (API)). The performance of certain of the operations may be distributed among the processors, not only residing within a single machine, but deployed across a number of machines. In some exemplary embodiments, the processors or processor-implemented components may be located in a single geographic location (e.g., within a home environment, an office environment, or a server farm). In other exemplary embodiments, the processors or processor-implemented components may be distributed across a number of geographic locations.

In the exemplary architecture of FIG. 9, the software architecture 906 may be conceptualized as a stack of layers where each layer provides particular functionality. For example, the software architecture 906 may include layers such as an operating system 902, libraries 920, applications 916 and a presentation layer 914. Operationally, the applications 916 or other components within the layers may invoke application programming interface (API) calls 908 through the software stack and receive messages 912 in response to the API calls 908. The layers illustrated are representative in nature and not all software architectures have all layers. For example, some mobile or special purpose operating systems may not provide a frameworks/middleware 918, while others may provide such a layer. Other software architectures may include additional or different layers.

The operating system 902 may manage hardware resources and provide common services. The operating system 902 may include, for example, a kernel 922, services 924 and drivers 926. The kernel 922 may act as an abstraction layer between the hardware and the other software layers. For example, the kernel 922 may be responsible for memory management, processor management (e.g., scheduling), component management, networking, security settings, and so on. The services 924 may provide other common services for the other software layers. The drivers 926 are responsible for controlling or interfacing with the underlying hardware. For instance, the drivers 926 may include display drivers, camera drivers, Bluetooth® drivers, flash memory drivers, serial communication drivers (e.g., Universal Serial Bus (USB) drivers), Wi-Fi® drivers, audio drivers, power management drivers, and so forth depending on the hardware configuration.

The libraries 920 provide a common infrastructure that is used by the applications 916 or other components or layers. The libraries 920 provide functionality that allows other software components to perform tasks in an easier fashion than to interface directly with the underlying operating system 902 functionality (e.g., kernel 922, services 924 or drivers 926). The libraries 920 may include system libraries 944 (e.g., C standard library) that may provide functions such as memory allocation functions, string manipulation functions, mathematical functions, and the like. In addition, the libraries 920 may include API libraries 946 such as media libraries (e.g., libraries to support presentation and manipulation of various media format such as MPREG4, H.264, MP3, AAC, AMR, JPG, PNG), graphics libraries (e.g., an OpenGL framework that may be used to render 2D and 3D in a graphic content on a display), database libraries (e.g., SQLite that may provide various relational database functions), web libraries (e.g., WebKit that may provide web browsing functionality), and the like. The libraries 920 may also include a wide variety of other libraries 948 to provide many other APIs to the applications 916 and other software components/modules.

The frameworks/middleware 918 (also sometimes referred to as middleware) provide a higher-level common infrastructure that may be used by the applications 916 or other software components/modules. For example, the frameworks/middleware 918 may provide various graphic user interface (GUI) functions, high-level resource management, high-level location services, and so forth. The frameworks/middleware 918 may provide a broad spectrum of other APIs that may be utilized by the applications 916 or other software components/modules, some of which may be specific to a particular operating system 902 or platform.

The applications 916 include built-in applications 938 or third-party applications 940. The third-party applications 940 may invoke the API calls 908 provided by the operating system 902 to facilitate functionality described herein.

The applications 916 may use built in operating system functions (e.g., kernel 922, services 924 or drivers 926), libraries 920, and frameworks/middleware 918 to create user interfaces to interact with users of the system. Alternatively, or additionally, in some systems interactions with a user may occur through a presentation layer, such as presentation layer 914. In these systems, the application/component “logic” can be separated from the aspects of the application/component that interact with a user.

FIG. 10 is a block diagram illustrating components (also referred to herein as “modules”) of a machine 1000, according to some exemplary embodiments, able to read instructions from a machine-readable medium (e.g., a machine-readable storage medium) and perform any one or more of the methodologies discussed herein. Specifically, FIG. 10 shows a diagrammatic representation of the machine 1000 in the example form of a computer system, within which instructions 1010 (e.g., software, a program, an application, an applet, an app, or other executable code) for causing the machine 1000 to perform any one or more of the methodologies discussed herein may be executed. As such, the instructions 1010 may be used to implement modules or components described herein. The instructions 1010 transform the non-programmed machine 1000 into a particular machine 1000 programmed to carry out the described and illustrated functions in the manner described. In alternative embodiments, the machine 1000 operates as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a laptop computer, a network router, a network switch, a network bridge, or any machine capable of executing the instructions 1010, sequentially or otherwise, that specify actions to be taken by machine 1000. Further, while only a single machine 1000 is illustrated, the term “machine” shall also be taken to include a collection of machines that individually or jointly execute the instructions 1010 to perform any one or more of the methodologies discussed herein.

The machine 1000 may include processors 1004, memory/storage 1006, and I/O components 1018, which may be configured to communicate with each other such as via a bus 1002. The memory/storage 1006 may include a memory 1014, such as a main memory, or other memory storage, and a storage unit 1016, both accessible to the processors 1004 such as via the bus 1002. The storage unit 1016 and memory 1014 store the instructions 1010 embodying any one or more of the methodologies or functions described herein. The instructions 1010 may also reside, completely or partially, within the memory 1014, within the storage unit 1016, within at least one of the processors 1004 (e.g., within the processor's cache memory), or any suitable combination thereof, during execution thereof by the machine 1000. Accordingly, the memory 1014, the storage unit 1016, and the memory of processors 1004 are examples of machine-readable media.

As used herein, the term “machine-readable medium,” “computer-readable medium,” or the like may refer to any component, device or other tangible media able to store instructions and data temporarily or permanently. Examples of such media may include, but are not limited to, random-access memory (RAM), read-only memory (ROM), buffer memory, flash memory, optical media, magnetic media, cache memory, other types of storage (e.g., Erasable Programmable Read-Only Memory (EEPROM)) or any suitable combination thereof. The term “machine-readable medium” should be taken to include a single medium or multiple media (e.g., a centralized or distributed database, or associated caches and servers) able to store instructions. The term “machine-readable medium” may also be taken to include any medium, or combination of multiple media, that is capable of storing instructions (e.g., code) for execution by a machine, such that the instructions, when executed by one or more processors of the machine, cause the machine to perform any one or more of the methodologies described herein. Accordingly, a “machine-readable medium” may refer to a single storage apparatus or device, as well as “cloud-based” storage systems or storage networks that include multiple storage apparatus or devices. The term “machine-readable medium” excludes signals per se.

The I/O components 1018 may include a wide variety of components to provide a user interface for receiving input, providing output, producing output, transmitting information, exchanging information, capturing measurements, and so on. The specific I/O components 1018 that are included in the user interface of a particular machine 1000 will depend on the type of machine. It will be appreciated that the I/O components 1018 may include many other components that are not shown in FIG. 10. The I/O components 1018 are grouped according to functionality merely for simplifying the following discussion and the grouping is in no way limiting. In various exemplary embodiments, the I/O components 1018 may include output components 1026 and input components 1028. The output components 1026 may include visual components (e.g., a display such as a plasma display panel (PDP), a light emitting diode (LED) display, a liquid crystal display (LCD), a projector, or a cathode ray tube (CRT)), acoustic components (e.g., speakers), other signal generators, and so forth. The input components 1028 may include alphanumeric input components (e.g., a keyboard, a touch screen configured to receive alphanumeric input, a photo-optical keyboard, or other alphanumeric input components), point based input components (e.g., a mouse, a touchpad, a trackball, a joystick, a motion sensor, or other pointing instrument), tactile input components (e.g., a physical button, a touch screen that provides location or force of touches or touch gestures, or other tactile input components), audio input components (e.g., a microphone), and the like. The input components 1028 may also include one or more image-capturing devices, such as a digital camera for generating digital images or video.

In further exemplary embodiments, the I/O components 1018 may include biometric components 1030, motion components 1034, environmental components 1036, or position components 1038, as well as a wide array of other components. One or more of such components (or portions thereof) may collectively be referred to herein as a “sensor component” or “sensor” for collecting various data related to the machine 1000, the environment of the machine 1000, a user of the machine 1000, or a combinations thereof.

Communication may be implemented using a wide variety of technologies. The I/O components 1018 may include communication components 1040 operable to couple the machine 1000 to a network 1032 or devices 1020 via coupling 1022 and coupling 1024 respectively. For example, the communication components 1040 may include a network interface component or other suitable device to interface with the network 1032. In further examples, communication components 1040 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1020 may be another machine or any of a wide variety of peripheral devices (e.g., a peripheral device coupled via a Universal Serial Bus (USB)). Moreover, the communication components 1040 may detect identifiers or include components operable to detect identifiers.

As will be appreciated by one of skill in the art, the present invention may be embodied as a method (including, for example, a computer-implemented process, a business process, and/or any other process), apparatus (including, for example, a system, machine, device, computer program product, and/or the like), or a combination of the foregoing. Accordingly, embodiments of the present invention may take the form of an entirely hardware embodiment, an entirely software embodiment (including firmware, resident software, micro-code, etc.), or an embodiment combining software and hardware aspects that may generally be referred to herein as a “system.” Furthermore, embodiments of the present invention may take the form of a computer program product on a computer-readable medium having computer-executable program code embodied in the medium.

Embodiments of the present invention are described above with reference to flowchart illustrations and/or block diagrams of methods, apparatus (systems), and computer program products. It will be understood that each block of the flowchart illustrations and/or block diagrams, and/or combinations of blocks in the flowchart illustrations and/or block diagrams, can be implemented by computer-executable program code portions. These computer-executable program code portions may be provided to a processor of a general purpose computer, special purpose computer, or other programmable data processing apparatus to produce a particular machine, such that the code portions, which execute via the processor of the computer or other programmable data processing apparatus, create mechanisms for implementing the functions/acts specified in the flowchart and/or block diagram block or blocks.

Unless defined otherwise, all technical and scientific terms used herein have the same meaning as commonly understood by one of ordinary skill in the art to which this invention belongs. Although any methods and materials similar or equivalent to those described herein can also be used in the practice or testing of the present invention, exemplary methods and materials are now described. All publications mentioned herein are incorporated herein by reference to disclose and describe the methods and/or materials in connection with which the publications are cited.

It must be noted that as used herein and in the appended claims, the singular forms “a”, “an,” and “the” include plural referents unless the context clearly dictates otherwise. Thus, for example, reference to “a stimulus” includes a plurality of such stimuli and reference to “the signal” includes reference to one or more signals and equivalents thereof known to those skilled in the art, and so forth.

Any publications discussed herein are provided solely for their disclosure prior to the filing date of the present application. Nothing herein is to be construed as an admission that the present invention is not entitled to antedate such publication by virtue of prior invention. Further, the dates of publication provided may differ from the actual publication dates which may need to be independently confirmed.

Where a phrase similar to “at least one of A, B, or C,” “at least one of A, B, and C,” “one or more A, B, or C,” or “one or more of A, B, and C” is used, it is intended that the phrase be interpreted to mean that A alone may be present in an embodiment, B alone may be present in an embodiment, C alone may be present in an embodiment, or that any combination of the elements A, B and C may be present in a single embodiment; for example, A and B, A and C, B and C, or A and B and C.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources.

As the phrase is used herein, a processor may be “configured to” perform a certain function in a variety of ways, including, for example, by having one or more general-purpose circuits perform the function by executing particular computer-executable program code embodied in computer-readable medium, and/or by having one or more application-specific circuits perform the function.

Embodiments of the present invention are described above with reference to flowcharts and/or block diagrams. It will be understood that phases of the processes described herein may be performed in orders different than those illustrated in the flowcharts. In other words, the processes represented by the blocks of a flowchart may, in some embodiments, be performed in an order other than the order illustrated, may be combined or divided, or may be performed simultaneously. It will also be understood that the blocks of the block diagrams illustrate, in some embodiments, merely conceptual delineations between systems, and one or more of the systems illustrated by a block in the block diagrams may be combined or share hardware and/or software with another one or more of the systems illustrated by a block in the block diagrams. Likewise, a device, system, apparatus, and/or the like may be made up of one or more devices, systems, apparatuses, and/or the like. For example, where a processor is illustrated or described herein, the processor may be made up of a plurality of microprocessors or other processing devices which may or may not be coupled to one another. Likewise, where a memory is illustrated or described herein, the memory may be made up of a plurality of memory devices which may or may not be coupled to one another.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

While certain exemplary embodiments have been described and shown in the accompanying drawings, it is to be understood that such embodiments are merely illustrative of, and not restrictive on, the broad invention, and that this invention is not limited to the specific constructions and arrangements shown and described, since various other changes, combinations, omissions, modifications and substitutions, in addition to those set forth in the above paragraphs, are possible. Those skilled in the art will appreciate that various adaptations and modifications of the just described embodiments can be configured without departing from the scope and spirit of the invention. Therefore, it is to be understood that, within the scope of the appended claims, the invention may be practiced other than as specifically described herein.

What is claimed is:

1. An audio control system comprising:
a radio frequency transmitter comprising a radio frequency antenna and a digital storage medium comprising identification data encoded thereon,
wherein the radio frequency transmitter is configured to transmit a radio frequency comprising a data packet containing the identification data;
a radio frequency receiver communicably engaged with the radio frequency transmitter,
wherein the radio frequency receiver is configured to receive the transmitted radio frequency and process the data packet to decode the identification data;
a controller communicably engaged with the radio frequency receiver to receive the decoded identification data,
wherein the controller is configured to process the decoded identification data to identify at least one user associated with the identification data,
wherein, upon identifying the at least one user, the controller is configured to apply one or more audio controls to a digital audio output; and
at least one loudspeaker operably engaged with the controller to render the digital audio output,
wherein the one or more audio controls comprise lowering a volume level of the digital audio output at the at least one loudspeaker to a preset level.

2. The audio control system of claim 1 wherein the one or more audio controls comprise one or more preset volume parameters associated with the at least one user.

3. The audio control system of claim 1 wherein the radio frequency receiver is configured to monitor a strength of the transmitted radio frequency to determine whether the radio frequency transmitter is outside of a specified range.

4. The audio control system of claim 3 wherein the radio frequency receiver is configured to communicate a signal to the controller in response to determining that the radio frequency transmitter is outside of the specified range.

5. The audio control system of claim 4 wherein the controller is configured to raise the volume level of the digital audio output to a preset level at the at least one loudspeaker in response to the signal from the radio frequency receiver.

6. The audio control system of claim 1 wherein the radio frequency transmitter comprises a passive radio frequency identification tag.

7. The audio control system of claim 6 wherein the radio frequency receiver comprises a radio frequency transceiver configured to energize the passive radio frequency identification tag to transmit the radio frequency.

8. The audio control system of claim 1 wherein the one or more audio controls comprise a first set of audio controls configured for a first user and a second set of audio controls configured for a second user, wherein the first set of audio controls is different from the second set of audio controls.

9. The audio control system of claim 8 wherein the controller is configured to identify the first user or the second user in response to processing the decoded identification data.

10. An audio control system comprising:
a sensor device configured to sense a presence of an occupant in an interior environment;
a controller communicably engaged with the sensor device,
wherein the sensor device is configured to send a sensor input signal to the controller in response to sensing the presence of the occupant in the interior environment,
wherein the controller is configured to process the sensor input signal according to at least one processing framework to identify at least one occupant type,
wherein, upon identifying the at least one occupant type, the controller is configured to apply one or more audio controls to a digital audio output; and
at least one loudspeaker operably engaged with the controller to render the digital audio output,
wherein the one or more audio controls comprise lowering a volume level of the digital audio output at the at least one loudspeaker to a preset level.

11. The audio control system of claim 10 wherein the sensor device is selected from the group consisting of an acoustic transducer, a digital camera, an optical sensor, an ultrasonic sensor, an imaging sensor, an infrared sensor, and a passive infrared sensor.

12. The audio control system of claim 10 wherein the one or more audio controls comprise a first set of audio controls configured for a first occupant type and a second set of audio controls configured for a second occupant type, wherein the first set of audio controls is different from the second set of audio controls.

13. The audio control system of claim 10 wherein the at least one processing framework is configured to identify the at least one occupant type according to a voice input from an occupant received at the sensor device.

14. The audio control system of claim 10 wherein the at least one processing framework is configured to identify the at least one occupant type according to an image recognition framework.

15. The audio control system of claim 14 wherein the sensor device comprises a digital camera.

16. An audio control system comprising:
a mobile electronic device configured to transmit at least one wireless signal comprising at least one data packet;
a controller configured to receive the at least one wireless signal from the mobile electronic device and process the at least one data packet according to at least one processing framework to identify the mobile electronic device;
a first loudspeaker located in a first location of an interior environment and configured to render an audio output, wherein the first loudspeaker is operably engaged with the controller to control a first volume level of the audio output; and
a second loudspeaker located in a second location of the interior environment and configured to render the audio output, wherein the second loudspeaker is operably engaged with the controller to control a second volume level of the audio output,
wherein the controller is configured to determine a proximity of the mobile electronic device relative to the first location of the interior environment and the second location of the interior environment,
wherein the controller is configured to independently control the first volume level of the first loudspeaker and the second volume level of the second loudspeaker according to the proximity of the mobile electronic device relative to the first location of the interior environment or the second location of the interior environment.

17. The audio control system of claim 16 wherein the controller is configured to process the at least one data packet to determine at least one occupant type or occupant identity.

18. The audio control system of claim 17 wherein the controller is configured to control the first volume level of the first loudspeaker and/or the second volume level of the second loudspeaker according to the at least one occupant type or the occupant identity.

19. The audio control system of claim 16 wherein the mobile electronic device is selected from the group consisting of a passive radio frequency identification tag, a smart phone, a radio frequency transmitter, a smart watch, and a wearable activity tracker.

20. The audio control system of claim 16 wherein the controller further comprises a user interface configured to enable a user to configure one or more audio controls for the first loudspeaker and the second loudspeaker.
